(19) United States
(12) Patent Application Publication
(10) Pub. No.: US 2002/0169708 A1
(43) Pub. Date: Nov. 14, 2002

(54) Competitive sealed bidding system and method

(76) Inventor: Errol D. Chittenden, Irving, TX (US)

Correspondence Address: J. Robert Brown, Jr., HUNTON & WILLIAMS, Energy Plaza, 30th Floor, 1601 Bryan Street, Dallas, TX, 75201-3402, US

(21) Appl. No.: 10/116,629

(22) Filed: Apr. 3, 2002

Related U.S. Application Data
(60) Provisional application No. 60/281,450, filed on Apr. 4, 2001.

(51) Int. Cl. G06F 17/60

(52) U.S. Cl. 705/37

(57) ABSTRACT

A method for competitively sealed bidding on debt obligations over a computer network is provided. The method includes inputting data into the computer network. The data associated with a debt obligation desired by a borrower including a bid due date. The method includes inputting data into the computer network, the data associated with a bid including a rate of the debt obligation by a lender to underwrite the debt obligation desired by the borrower. The method further includes concealing from the borrower until the bid due date at least a portion the rate of the debt obligation bid by the lender on the computer network. A system for competitively sealed bidding on debt obligations over a computer network is also provided.

### TECHNICAL FIELD OF THE INVENTION

The present invention relates generally to competitive sealed bidding over a computer network, and more particularly, but not by way of limitation, to an improved system and method for competitively sealed bidding on debt obligations over a computer network.

### BACKGROUND OF INVENTION

Debt obligations are issued by government and industry borrowers to fund capital assets and expansion. The funds for these debt obligations are provided by lenders such as banks, insurance and other corporations, and private individuals. Borrowers employ various methods to obtain these debt obligation under the most favorable terms. The most common methods are competitive sealed bidding and auctions.

Under both methods, the borrower specifies general terms, such as the amount of funds and length of repayment period for the desired debt obligation. When the debt obligations are sold at an auction, the lenders offer to provide the debt obligation terms desired by the borrower at a cost of money, such as an interest rate, bid by the lender. If the interest rate bid by a specific lender represents the most favorable terms to the borrower bid thus far in the auction process, then that lender becomes the auction's best bidder or leader. The lender with the current best bid is readily ascertainable since the interest rate or other known value is typically the subject of the auction award. The auction continues for a specified time period, and the debt obligation is awarded to the lender with the current best bid at the close of the auction.

A frequent problem with the auction method occurs when the first lender to bid for the debt obligation at the auction offers a low or aggressive bid. Potential lenders that might otherwise bid on the debt obligation may decide not to bid since their bid would be the same or less competitive than the current best bid. Under these circumstances, the borrower is unable to determine whether more than one bid would have been received. Such an occurrence could render the auction invalid where the borrower is under an obligation to receive more than one bid for the debt obligation.

Also, lenders may desire to participate in the auction, but are preoccupied with other business, auctions, or merely have scheduling conflicts with the narrow window of time specified for a particular auction. Lack of lender participation reduces the competitiveness of the auction process and is a severe detriment to the borrower's ultimate cost for the debt obligation.

When debt obligations are sold under a competitive sealed bidding method, the borrower typically place notification of the offering in a publication and include a calendar date by which sealed bids are due from lenders. The sealed bid requests and sealed bid responses are typically mailed or hand-delivered to the lenders and returned by mail or hand-delivered to the borrower. The borrower opens the sealed bids at a predetermined date and time and determines the most lowest and best sealed bid for the debt obligation. The competitive sealed bidding method eliminates the problems associated with auctioning.

To this end, a need exists for a system and method for competitively sealed bidding debt obligations that eliminates the problems associated with auctioning debt obligations and that further overcomes the problems and disadvantages associated with conventional methods of obtaining debt obligation, such as lease debt, funding.

### SUMMARY OF THE INVENTION

It should be understood that competitiveness is less problematic for the borrower when the debt obligations are large bond offering that attract big institutions and large investors. However, debt obligations involving lower debt amounts, such as leases, are less profitable and less attractive to these big institutions and large investors. For this reason, smaller bond offerings and leases are typically more costly debt obligations relative to the cost of money for larger bond debt. For this reason, smaller debt offerings attract fewer bidders, which reduces competitiveness and may affect the legitimacy of the sealed bid process.

In addition, leases often contain non-appropriation clauses allowing the lessee to discontinue payments if the governing body fails to annually ratify the lease agreement. Leases are also unique in that the borrower frequently requires that the obligation include the option to pay-off the entire balance of the debt obligations at any time. Such a requirement is problematic since governmental entities generally refuse to allow lenders to include pre-payment penalties. However, these entities typically allow a purchase option price (POP) that allows the lender a means of recouping loan costs associated with the lease obligation when the borrower pays-off the debt obligation early.

Lenders submitting sealed bids on leases are required to bid not only on the cost, such as the interest rate or factor, but also the POP rate. Borrowers interested in pre-paying the lease prior to the end of the original lease term will be more concerned with the POP rate while other borrowers will view the interest rate as the primary consideration. Therefore, unlike bond offerings where the only consideration is the interest rate, for example, bids for lease obligation must be evaluated and awarded based upon a subjective analysis of each borrower's needs. For this reason, leases are not appropriate for auctions and are generally competitively bid by sealed bid or privately placed. These considerations place further strains on the competitiveness of lease obligations, particularly those involving small debt amounts. The above list includes various problems associated with the competitive sealed bid process that are overcome by the present invention.

In one aspect, the present invention is directed to an innovative method for competitively sealed bidding on debt obligations over a computer network. The method includes inputting data into the computer network, the data associated with a debt obligation desired by a borrower including a sealed bid due date. The method includes inputting data into the computer network, the data associated with a sealed bid request including a rate of the debt obligation by a lender to underwrite the debt obligation desired by the borrower. The method further includes concealing from the borrower until the sealed bid due date at least the rate of the debt obligation bid by the lender on the computer network.

In one embodiment, the present invention provides a method of competitively sealed bidding for debt obligations over a computer network having a borrower system in communication with a lender system. The method includes inputting, via the borrower system, data associated with a debt obligation desired by a borrower including a sealed bid due date. The method includes inputting, via the lender system, data associated with a sealed bid request by the lender to underwrite the debt obligation desired by the borrower, the sealed bid including a rate of the debt obligation. The method further includes concealing from the borrower system until the sealed bid due date at least the rate of the debt obligation bid by the lender.

In another embodiment, the present invention provides a method for competitively sealed bidding on lease obligations over a computer network. The method includes inputting data into the computer network, the data associated with a lease obligation desired by a borrower including a sealed bid due date. The method includes inputting data into the computer network, the data associated with a sealed bid request including a lease interest rate and a purchase option price by a lender to underwrite the lease obligation desired by the borrower. The method further includes concealing from the borrower until the sealed bid due date at least the lease interest rate and the purchase option price of the lease obligation bid by the lender on the computer network.

In one embodiment of the present invention, a system for competitively sealed bidding on debt obligations over a computer network is provided. The system includes a database component operative to maintain a database identifying a debt obligation desired by a borrower including a sealed bid due date. The database further identifying a sealed bid request including a rate of the debt obligation by a lender to underwrite the debt obligation desired by the borrower. The system further including a security component operative to conceal at least a portion of the rate of the debt obligation bid by the lender from the borrower until the sealed bid due date.

In yet another embodiment, a computer-readable medium having computer-executable instructions for performing a method is provided. The method includes inputting data into the computer network, the data associated with a debt obligation desired by a borrower including a sealed bid due date. The method includes inputting data into the computer network, the data associated with a sealed bid request including a rate of the debt obligation by a lender to underwrite the debt obligation desired by the borrower. The method includes concealing from the borrower until the sealed bid due date at least the rate of the debt obligation bid by the lender on the computer network.

Other objects, features, and advantages of the present invention will be apparent to those skilled in the art from the following detailed description when read in conjunction with the accompanying drawings and appended claims.

### BRIEF DESCRIPTION OF THE SEVERAL VIEWS OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 is a block diagram of a competitive sealed bidding system constructed in accordance with the present invention employed on a computer network;

FIG. 2 is a diagrammatic illustration of another aspect of the competitive sealed bidding system of the present invention;

FIG. 3 is a flow-chart showing one embodiment of a method for a borrower to offer debt obligation for competitive sealed bid in accordance with the present invention;

FIG. 4 is a flow-chart showing one embodiment of a method for a lender to competitively sealed bid on debt obligations in accordance with the present invention;

FIG. 5 is an illustration of a computer-coded algorithm for computing a purchase option price; and

FIG. 6 is a block diagram of another embodiment of the competitive sealed bidding system shown with a database and security component.

### DETAILED DESCRIPTION OF THE INVENTION

It should be understood at the outset that although an exemplary implementation of the present invention is illustrated below, the present invention may be implemented using any number of techniques, whether currently known or in existence. The present invention should in no way be limited to the exemplary implementations, drawings, and techniques illustrated below, including the exemplary design and implementation illustrated and described herein.

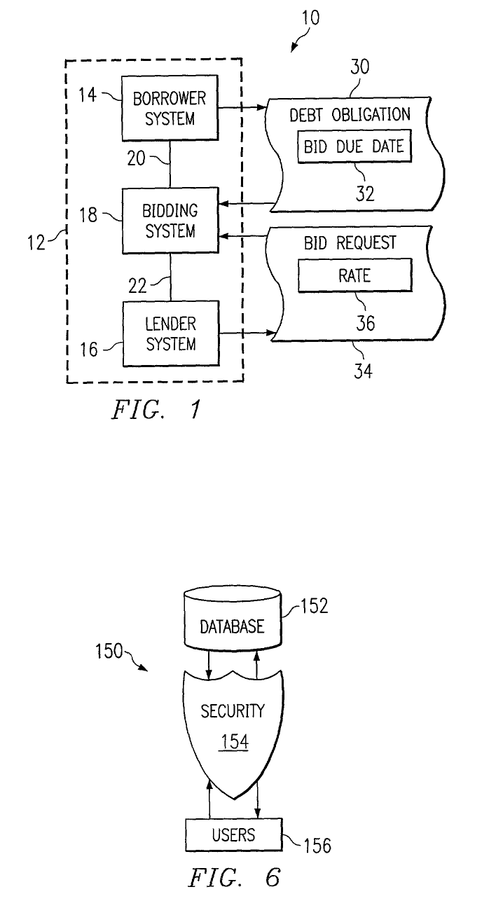

FIG. 1 is a block diagram of one embodiment of a system 10 constructed in accordance with the present invention. The system 10 may be employed over a computer network 12, such as, but not limited to, the Internet or World Wide Web, a local or wide-area network. Furthermore, the system 10 may be embodied in a computer-readable medium including, but not limited to, floppy or hard magnetic disks, optical-discs, laser-discs, ROM, RAM or other conventional means of storage now used or subsequently employed for such purposes. In one embodiment, the computer network 12 includes a borrower system 14 and a lender system 16 connected to a sealed bidding system 18.

The borrower and lender systems 14 and 16 may be personal computers, network workstations, network appliances, web appliances, personal digital assistants, wireless devices, such as cellular or digital telephones or pagers, or other devices currently employed or later developed for transmitting and communicating data. It should be understood that while only a single borrower system 14 and lender system 16 are shown in the current embodiment, in another embodiment, the system 10 (not shown) includes a plurality of borrower systems 14 and a plurality of lender systems 16.

The sealed bidding system 18 may be a personal computer, network server, Internet web site, or other system capable of communicating with or being accessed by the borrower system 14 and lender system 16. The sealed bidding system 18 may communicate with the borrower system 14 and lender system 16 via communication lines 20 and 22 adapted to transport data messages therebetween.

The borrower system 14 may be employed by borrowers for the purpose of obtaining information for funding debt obligations desired by the borrower. These borrowers may include federal, state and local governments, cities, parish and school districts, vocational and technical districts, or any other governmental or non-profit entity, such as, for example, hospitals. It should be understood that while the present embodiment discloses numerous advantages of competitive sealed bidding with reference to tax-exempt debt obligations, taxable debt obligations whether governmental or private are within the spirit and scope of the present embodiment and benefit from the advantages of the present invention.

The lender system 16 may be employed by individuals and organizations in the business of loaning money, such as banks, insurance companies, institutional and corporate inventors, and high net worth individuals as defined by the Securities and Exchange Commission.

The borrower, using the borrower system 14, inputs data into the sealed bidding system 18. The data associated with a debt obligation 30 desired by the borrower. The debt obligation 30 may be any funding desired by the borrower and may be represented as a loan, a bond, a lease, a lease backed revenue bond or any other debt instrument having any type of debt obligation terms. The terms of the debt obligation must be specified and will be discussed hereinafter in greater detail.

The requirements of the debt obligation 30 include a sealed bid due date 32 and may include a calendar date and time when sealed bids for the debt obligation should be received for competitive sealed bidding purposes. However, it is not necessary that the sealed bid due date 32 be received initially or in any particular order with respect to the additional information relating to the debt obligation 30.

According to one aspect, the due date 32, will be hours, or more likely, days or weeks after the debt obligation 30 is initially input into the sealed bidding system 18. The present invention employs a number of innovative techniques, which will be discussed below, for maintaining the confidentiality and sealed-bid nature of the competitive sealed bidding process, which is another advantage of the present invention and is significantly different than auctioning systems or processes which may auction debt obligations in a matter of minutes.

In response to the debt obligation 30 desired by the borrower, the lender, using the lender system 18, inputs data into the sealed bidding system 18 associated with a sealed bid 34 request including, for example, a rate 36 of the debt obligation 30 by the lender to underwrite or provide the debt obligation 30 desired by the borrower. The term sealed bid 34 or sealed bid 34 request may also include, but not be limited to, requests for proposals (RFPs) and requests for qualifications (RFQs).

The term sealed bid 34 is intended only to indicate that the bid process may provide that at least some portion of the terms offered by the borrower are withheld from the borrower or issuer until such time specified by the borrower or issuer. In one aspect, that portion withheld from the borrower or issuer may be a portion of the terms offered by the lender, such as the interest rate, while according to other aspects the POP may be withheld, or both the interest rate and POP may be withheld according to other aspects.

The rate 36 bid by the lender may be, for example, an interest rate or factor where the debt obligation 30 is a lease. It should be appreciated that, in some instances, debt obligations may not technically include leases for various legal reasons. However, for the purposes herein, the term debt obligation 30 is intended to include any manner of lease, whether or not the lease is legally a debt obligation.

According to another aspect of the present invention, the sealed bidding system 18 may be provided with input capabilities. In this aspect, the lender may communicate debt obligation 30 information, such as by telephone or mail, and the debt obligation 30 information may be entered directly into the sealed bidding system 18 via the local input capabilities directly coupled to the sealed bidding system 18 and not remotely from the borrower system 14.

Where the rate 36 is an interest rate, the rate may be represented as a fixed or flat rate, compounded rate, based upon a period such as annually or over some other period, an adjustable or variable rate, or associated with mechanism, such as a published interest rate. Where the debt obligation is a bond, the rate 36 may represent a true or net interest cost where the debt obligation is a bond. The rate 36 may also represent weighted average coupons or other computational or financial systems of representing the cost of money for any type of debt obligations. According to one aspect, the sealed bidding system 18 may conceal from the borrower system 14 portions of the sealed bid 34 such as the rate 36 of the debt obligation 30 bid by the lender until the sealed bid due date 32. One advantage of the system 10 is that it provides that the borrower may obtain data associated with the bid by the lender, generally, yet prevents the borrower from obtaining the specifics, such as the rate 36 data, prior to the sealed bid due date 32.

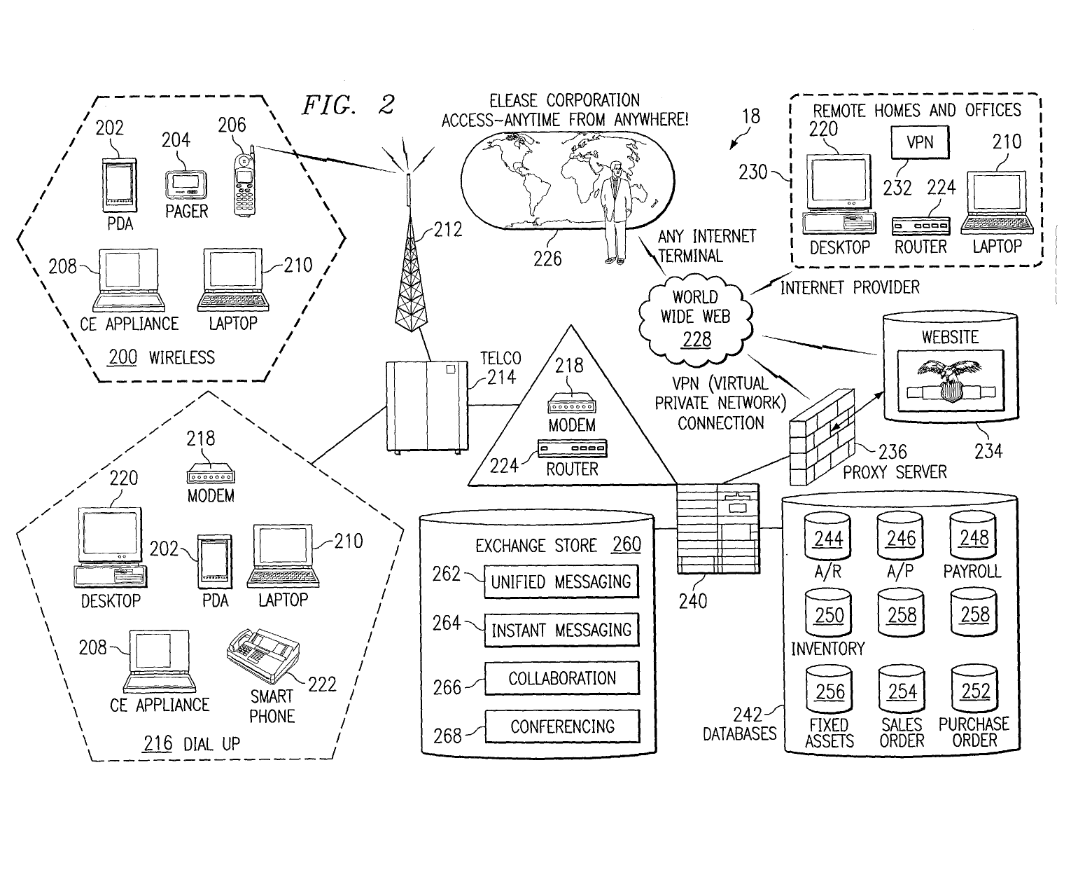

FIG. 2 illustrates the system 10 according to another aspect of the present invention. In this aspect the borrower system 14 and lender system 16 may access the sealed bidding system 18 utilizing one of a variety of wireless devices 200, such as personal digital assistance (PDA) 202, pagers 204, wireless telephones 206, wireless appliances 208, or any type of device currently existing or later used for achieving wireless electronic communication, such as, but not limited to, laptop 210 computers utilizing wireless communication for communicating with wireless communication networks 212.

The borrower system 14 and lender system 16 may also communicate with a standard telecommunication network 214 utilizing well-known or hereinafter developed communication techniques, such as by a dial-up connection 216 by, for example, a standard modem 218 coupled to devices such as a desktop computer 220, the personal digital assistant 202, the network appliance 208, the laptop 210 or a variety of other devices well known, such as, but not limited to, a smart phone 222.

The telecommunications network 214 or wireless network 212 may then communicate directly over the Internet or by hard-wired connection to the competitive sealed bidding system 18 via modems 218 or a router 224 or other similar network device. In addition, the borrower system 14 and lender system 16 may communicate with the competitive sealed bidding system 18 as an Internet terminal 226 accessible to the World Wide Web 228. Such a connection to the worldwide web 228 may be accomplished in a manner of well-known techniques such as, but not limited to, by the desktop computer 220, the laptop computer 210, via access from an internet service provider 230 through a standard connection or may be accomplished through a virtual private network (VPN) 232 or other connections such as routers 224.

As previously discussed, the sealed bidding system 18 may be a website 234 coupled with, for example, a proxy server 236 in the instances when a VPN 232 is utilized. The competitive sealed bidding system 18 may be deployed on a computer server 240 or other well-known devices for these purposes and may include, for example, a plurality of databases 242 including accounts receivable 244, accounts payable 246, payroll 248, inventory 250, purchase order 252, sales order 254, fixed assets 256, and one or more databases 258 for managing information related to the debt obligations including borrower information, lender information, and debt obligation information generally.

The competitive sealed bidding system 18 may further include an exchange store 260 deployed on the server 240 for managing messaging such as, but not limited to, unidentified messaging 262, instant messaging 264, collaboration 266, video conferencing 268, and a variety of other communication tools that are readily available and well known in the art as well as well as those developed hereafter for promoting electronic or other communications.

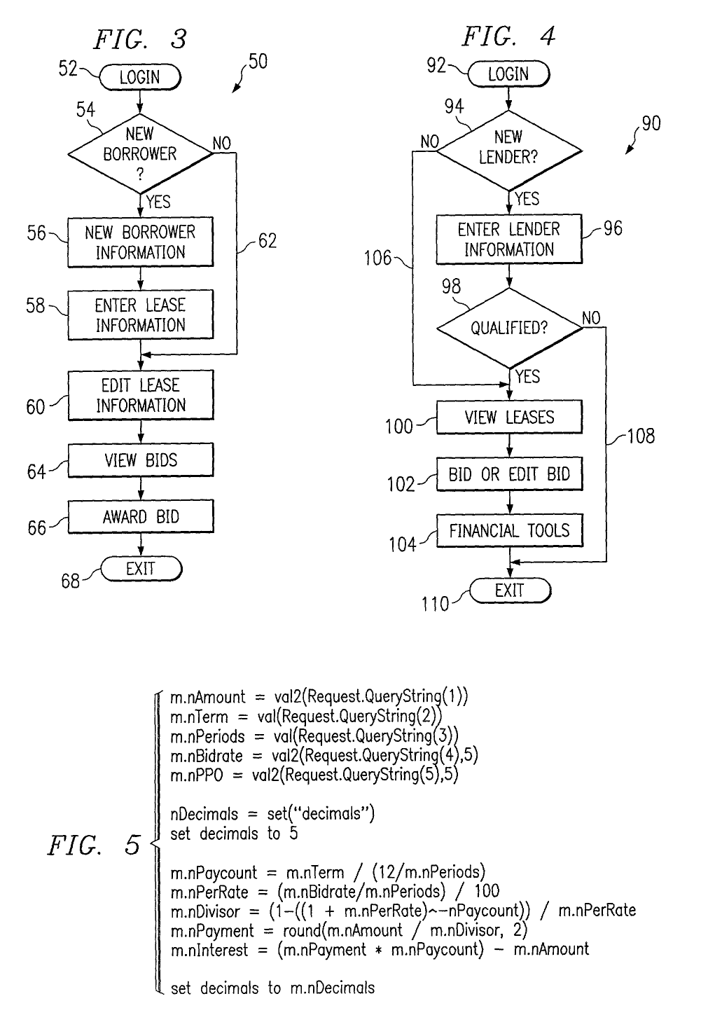

FIG. 3 describes the borrower portion 50 of the system 10 for obtaining sealed bids for a desired debt obligation 30. At a block 52, the borrower may be prompted to login to the system 10. Using the borrower system 14, equipped for example as a personal computer or network workstation with an Internet browser, the borrower connects to the sealed bidding system 18, which in one embodiment is an Internet web site programmed in a computer language such as hyper-text markup language (HTML) or JAVA.

It should be understood that a variety of computer architectures, operating platforms and programming languages may be employed for these purposes, will suggest themselves to one of ordinary skill in the art, and are within the spirit and scope of the present invention. Therefore, while the present embodiment of the system 10 may be deployable on the Internet, it may also be programmed as a client-server or other application deployed on a local, wide-area or other computer network.

At a block 54, the system 10 determines whether the login is associated with a new borrower. At a block 56, new borrowers may be prompted to enter their information, such as the type of borrower (for example city, state, school district), address, contact, and other general information, and a password.

At a block 58, the borrower is prompted to enter information about the obligation 30 on which the borrower wishes to receive sealed bids. The information that may be received by the system 10 includes the principle amount of the lease, term, frequency of payments, asset description, borrower identification numbers, whether the lease is tax- exempt, and the sealed bid due date 32. The sealed bid due date 32 may include a calendar date and a time, including time zone information. Additional information relevant to the obligation may also include, but not be limited to, the lease category, lease document number, asset description of the asset being purchased, the source of payments, the approval authority, the principal amount of the lease, the down payment, the net amount of the lease, the term of the lease, the type of interest rate, such as fixed, variable, or other, the frequency of the payments, the sealed bid opening date, the date funding is required, the structure of the payments, such as whether it is level debt service, whether the debt obligation requires a tax exempt opinion and whether such is provided, whether the debt obligation 30 is subject to appropriations, whether the debt obligation 30 is related to in the essential government purpose, and whether bank qualification is required, and the dates the debt obligation 30 is published for sealed bid.

While the present embodiment discloses the advantages of employing the system 10 for lease obligations, it will be appreciated that the system 10 is equally well adapted for competitively sealed bidding a variety of debt obligations previously discussed. Modifications to the system 10 for competitively sealed bidding other types of debt obligations are within the spirit and scope of the present invention and will readily suggest themselves to one of ordinary skill in the art when taken with the present embodiment as described and shown.

Additionally, the financial information relevant to the borrower is necessary, and the system 10 provides a variety of options for accessing such information. It is advantageous to have financial information readily accessible to the lender within the system 10, so that the lender can quickly and easily determine the risk associated with the borrower.

Also, greater accessibility increases participation and competitiveness since the lender can make all necessary decisions related to the debt obligation 30 at one time and from one location. Examples of the type and substance of information accessible to lenders about borrowers via the system 10 are financial ratings information that may be accessible by linking to the appropriate web site, importing or embedding objects in the respective borrower or debt obligation information. Examples of such financial information useful to the borrower include access to rating agencies so that the borrower may make an informed decision with respect to the capabilities and financial viability of the lenders, such rating information may be directly accessed, such as via a hyperlink, or, according to other aspects of the present invention, the competitive sealed bidding system 18 may directly access the databases of, for example, Moody's, Standard & Poor's Corporation, and Fitch, which are trademarks owned by the respective companies. Access to such rating information may be achieved by a drop-down, fill-in, or pop-up windows, as examples of a user interface which may be utilized for providing easy access to such rating information.

Once the lease information has been entered into the system 10, the borrower may edit the lease information at a block 60. It is apparent that when logging on as a current borrower, the block 54 branches along a line 62 to the block 60 providing the borrower an opportunity to edit the terms of the debt obligation 30.

This is advantageous since under prior competitive sealed bidding schemes, the borrower is unable to modify the terms of the debt obligation once the sealed bid had been released or published. However, the system 10 provides the borrower with the ability to modify, at the block 60, the terms of the debt obligation at anytime. When the borrower modifies the debt obligation 30, this may present a problem for lenders that have previously placed a sealed bid for the debt obligation 30, since this may alters the terms of the sealed bid without the lender's knowledge.

To address this problem, the system 10 has a variety of methods for notifying the lender of the change to the terms of the debt obligation 30 by the borrower. Methods of notifying the lender include emailing the lender with the changes, emailing administrative personnel operating the system 10 so that telephone confirmation may be accomplished, requiring email confirmation receipt of the changes by the lender, or a variety of other messaging systems to ensure the lender is apprized of the change.

At a block 64, the borrower can view the sealed bids received by lenders. The method of lender participation with the system 10 will be discussed hereinafter with regard to FIG. 3. However, another advantage of the present invention is that the borrower may review the debt obligations 30 placed out for sealed bid to determine lender response.

In one embodiment of the present invention, the borrower can review the total number of sealed bids received on the debt obligation 30, as well as, information on the names and, for example, addresses of the lenders that have submitted sealed bids 34. In this manner, the borrower can determine the lender response to the sealed bid and take appropriate actions, such a notifying lender when there are few lender respondents, that the sealed bids are requested.

The system 10 provides the additional advantage of preventing the borrower or other lenders from viewing the critical sealed bid data, such as the interest rate, that a lender bid for a particular debt obligation 30 until a predetermined time, such as the sealed bid due date 32. In this manner, the borrower has the advantage of ensuring a competitive turn-out for sealed bidding while not compromising the actual sealed bid 34.

The system 10 promotes greater competition which generally translates into a better cost to the borrower. Although the lenders may be aware of sealed bids from other lender, the lender necessarily bids more competitive rates 36 because the lender does not know what other lenders have bid for the debt obligation 30.

Another advantage of the present invention is that borrowers with low volumes of debt obligations or small debt obligation amounts ordinarily have very few bidder which lessens competition and increases the borrower's costs. Providing a centralized location, such as the system 10, brings a large volume of borrowers and lender together. This increases lender participation, particularly with the small borrowers or debt obligations involving smaller amounts.

Once the sealed bid due date 32 has passed, the system 10 provides the borrower the opportunity to view all the sealed bids 34 received from the lenders. The sealed bid 34 results may be presented, according to one aspect of the present invention, as a table (not shown) including the lender's name, sealed bid rate 36, payment, total interest, total payment, POP, exceptions, and any other information useful to the borrower to select the most desirous sealed bid 34. This is advantageous, particularly where the debt obligation 30 is a lease, where several criteria must be evaluated to determine the most desirous sealed bid 34. For example, government leases require that the lender bid a purchase option price (POP) rate which relates to the cost for the borrower to pre-pay the lease. Therefore, when the borrower may be more likely to pay-off the lease obligation early, the borrower may be more concerned with the POP rate than the interest rate sealed bid 34 by the lender.

Such subjective analysis prevent such leases from effectively being auctioned, as are bonds that do not have such requirements. Therefore, only the system 10 is appropriate for government or other leases involving POP rates since only the specific borrower can weight and determine the impact that the interest rate and POP rates bid for the lease obligation may have on the desirability of each particular sealed bid. This is not to say that borrowers and lender bidding bonds or other debt obligations will not share in the advantages of the competitive bidding system 10, only that auction type structure are inadequate to address the needs of such lease obligations.

Once the borrower determines the most desirable sealed bid, the borrower may award the sealed bid 34 to a particular lender, at a block 66. The competitive bidding system 10 then notes the successful bidder, such as by flagging or other visual means, and notifies the winning lender, such as by email. The borrower may exit, at a block 68, or log-out of the competitive bidding system 10.

FIG. 4 illustrates a method 90 for the lender to competitively bid on debt obligations 30 with the competitive bidding system 10 of the present invention. At a block 92, the lender is prompted to login to the competitive bidding system 10. At a block 94, the competitive bidding system 10 determines whether the lender is a new lender. New lenders are required to enter lender information about their qualifications as potential lenders, at a block 96.

Lenders, as previously discussed, must qualify as banks, insurance companies, institutional or corporate investors., or high net worth individuals capable of funding debt obligations. New lenders enter lender information, such as name, address, and type of entity. At a block 98, the competitive bidding system 10 determines whether the lender is qualified to become an accredited lender. Providing lender prequalification is another advantage of the present invention since borrowers may safely accept a bid by any lender with the confidence that the lender is capable of funding the debt obligation 30. Qualification is based upon a number of factors including, but not limited to, financial capability as dictated by the borrower and some lenders may qualify for some, but not all bids. When a lender is qualified, at a block 100, the lender may view at least some of the leases available for bid.

The competitive bidding system 10 provides an organized and convenient method for the lender to view a large number of leases, including information about the borrowers offering the leases. The lender can view a summary of all the leases, and according to some aspects, select a particular debt obligation 30 offering and view the complete detail.

A frequent problem with lease bidding occurs where the borrower and lender are in different time zones. The lender may incorrectly assume a bid has been timely submitted when, in fact, the time zone difference caused the lender's bid to be submitted too late for consideration. The competitive bidding system 10 eliminates this problem by including the calendar date and time when the bids are due in the time-zone where the borrower or lender reside, and also, according to one aspect, a countdown clock. The countdown clock may be based upon the time zone of the borrower, since the borrower sets the sealed bid due date 32.

According to other aspects, the system 10 may display the time by which all bids are due, such as the sealed bid due date 32, based upon the time-zone in which the lenders and borrowed are located. For example, when a borrower or issuer in the Central Time Zone establishes a 5:00 p.m. sealed bid due date 32, the system 10 will display, on a display device (not shown) on the lender system 16, a 4:00 p.m. sealed bid due date 32 for a lender in a Mountain Time Zone desiring to bid on the debt obligation 30. In this manner, the system 10 eliminates any concerns or problems related to lenders and borrowers in different time-zones.

Thus, regardless of any time zone difference, the lender will always be aware of the actual time remaining to submit bids. In another embodiment, the countdown clock may be standardized to a universal time zone that applies to all borrowers and lenders to eliminate time zone problems. A variety of other methods of resolving these time differences may also be utilized and are within the spirit and scope of the present invention.

Where the lender desires to submit bids on a lease or edit the bid 34 previously submitted by the lender, the lender simply selects the appropriate debt obligations 30. At a block 102, the lender is provided the opportunity to submit the bid 34. Since all the pertinent information about the lender has been previously collected, as discussed above, the lender, according to one aspect, may only be required to submit the rate 36 information.

As previously discussed, the rate information may include the interest rate of the lease and may also require the POP rate. The specific information about the debt obligation 30 and the bid 34 submission capabilities of the competitive bidding system 10 may vary depending upon the type of debt obligation 30. However, the bid 34 information may include, but not be limited to, the payment amount, total payments, total interest, frequency of payments, as well as providing a table (not shown) illustrating the payment amount, interest, principal, and purchase price option for each period. Another advantage of the competitive bidding system 10 are the financial tools tailored for the debt obligation 30 to assist in the process and which are readily available to lenders.

The lender, at a block 104, is provided with a variety of tools to assist the lender in calculating the bids 34. These tools include a Tax Equivalent Yield Calculator adapted to assist lenders, such as banks, with determining the tax-exempt yield equivalents of a taxable yield rate.

This is accomplished by calculating factors including the tax-exempt yield, state tax exemption, federal tax rate, federal penalties such as, but not limited to, TEFRA Penalties, and the institution's cost of carry, for example. Such capabilities may be utilized by the lender to determine tax equivalent yield and a system function or calculator (not shown) may be provided, according to one aspect, for these computations.

This is another advantage of the competitive bidding system 10 in that such a calculator (not shown) allows lenders, such as banks, to quickly and easily ascertain a competitive bid 34 for tax-exempt leases relative to their ordinary lending terms. The tax equivalent yield, according to one aspect, may be calculated utilizing the following formula:

$$X = \frac{A - ( BA ) + ( CBA ) - ( DEC )}{1 - [ ( 1 - B ) C + B ]}$$

In the above formula for computing the tax equivalent yield, A is the tax exempt yield, B is the state franchise tax, C is the federal tax rate, D is the TEFRA penalty, E is the cost of funds percent, and X is the tax equivalent yield.

According to other aspects, another tool may be provided at the block 104 for calculating the POP to allow lenders to enter a POP price, and easily determine the effective POP schedule for the bid 34. Such calculation tool (not shown) simplifies the lender's bidding process, ensures accuracy, and allows the borrower to easily view and compare POP rates bid by various lenders.

FIG. 5 illustrates one aspect of computer source code utilized by the system 10 for computing the purchase option price (POP). It should be appreciated, however, that a variety of algorithms written in numerous computer languages may also be employed. This is another advantage of the present invention since this method simplifies the bidding process for the lender and reduces the likelihood of error caused by improper calculations or improper or incomplete completion of standardized bid forms.

Also, the tools available at the block 104 may include amortization schedules for the lease based on the interest rate submitted by the lender, and also incorporates the schedule for the lease adjusted for the POP price and recalculated to include the POP schedule. This is a convenient tool for both the lender and the borrower.

The block 102 illustrates another advantage of the competitive bidding system 10 and provides the bidder the opportunity to edit, modify or withdraw the bid 34. Lenders, in mail or hand-delivery sealed bidding processes, are forced to wait until the last minute to submit bids 34 because, as the interest rates fluctuate, so does to the borrower's costs and profitability at a given bid 34 rate 36.

Lenders frequently miss bid due dates 32 under older sealed bidding schemes because they are unable to deliver the bids 34, or last-minute interest rate swings make it impossible to timely submit the bid 34. Utilizing the system 10, the lender may submit a bid 34 and change or withdraw the bid at any time until the bid due date 32.

Thus, the present invention makes it easier for the lender to submit bids 34 and change bid rates 36, and also, gives the lenders a greater comfort level since they can change the rate 36 or withdraw the bid 34 completely if the interest rate market dramatically changes, at any time. Under this method, more bids 34 will be received and the bids 34 will be more competitive.

Unlike auctions that happen quickly at a particular time, lenders utilizing the system 10 may conveniently place the bid 34 either weeks, days or even hours before the bid due date 32. This further promotes competitive sealed bidding and reduced rates 36 for the borrower.

Once the lender completes and submits the bid 34, the information, excluding the interest rate and POP schedule, is available for viewing by the borrower. When the lender is a previously qualified lender, at the block 94, the lender jumps, along a line 106 to the block 100 and may immediately view leases. Also, a lender that fails to qualify, at a block 98, will be exited, along a line 108 from the system 10, to a block 110. Also, once the lender has finished viewing, editing or bidding, the lender may exit the system at the block 110.

Additional features of the system 10 may include administrative, utility, database elements, category, application design, menu and pull-down options, and automatic fields to improve the ease and simplicity of use by lenders, borrowers and administrators of the system 10.

According to yet another aspect, the present invention may further include a lease calculation device (not shown) for computing lease payments, similar in some mathematical aspects to amortization computations. The lease calculations derive interest rate information from an interest rate matrix including interest rates for various categories of entities, such as governmental entities of particular size or type. The interest rate matrix may be populated with comparable interest rate data obtained from third party sources, such as by published lists, or information available to the public about recently funded debt obligations or leases. The interest rate matrix may include a table for each category for from 1 through 20 years, or more.

According to one aspect, the interest rate matrix may be automatically populated, for efficiency, by computing prior mathematical relationships between given rates. For example, where it has been established over an average of years that the 4 year lease interest rate is, for example, 98.15% of the 5 year lease interest rate, the 4 year lease interest rate may be automatically computed from the 5 year lease interest rate. Thus by entering only the 2, 5, 10 and 15 year lease interest rates, the present invention is capable of automatically populating the remainder of the matrix for efficiency. This is another advantage of the present invention. In addition, borrowers frequently desire the capability to compute estimated lease payment amounts prior to placing debt obligations 30 for competitive bid 34. The present aspect provides an accurate and efficient means for providing this functionality.

FIG. 6 illustrates another aspect of a competitive sealed bidding system 150 shown with a database 152 and a security 154 component. In this embodiment, the competitive sealed bidding system 150 may be employed on a variety of computing type systems, as previously discussed, such as the server 240 connected to the World Wide Web 228, for example. The database component 152 is operative to maintain a database identifying a debt obligation, such as the debt obligation 30 previously discussed, a listing of borrowers, including borrower information, and lenders, including lender information.

The debt obligation 30 represents, for example a lease, desired by the borrower and includes the due date 32. The database component 152 is further operative to identify the bid request 34 of the debt obligation 30 by the lender to underwrite the debt obligation 30 desired by the borrower. The security component 154 is operative to conceal from the borrower the rate 36, including the interest rate and POP schedule, of the bid request 34 offered by the lender until, for example, the bid due date 32.

In this manner, where a user 156, such as the borrower using the borrower system 14, attempts to view the bids 34 related to the debt obligation 30 desired by the borrower, the security component 154 evaluates the bid due date 32 relative to the current date. The security component 154 prevents the borrower from viewing or obtaining the rate 36 portion of the lender's bid request 34 until the bid due date 32 Thus, it is apparent that there has been provided, in accordance with the present invention, a competitive sealed bidding system and method that satisfies one or more of the advantages set forth above. Although the preferred embodiment has been described in detail, it should be understood that various changes, substitutions, and alterations can be made herein without departing from the scope of the present invention, even if all of the advantages identified above are not present. For example, the various embodiments shown in the drawings herein illustrate that the present invention may be implemented and embodied in a variety of different ways that still fall within the scope of the present invention.

Also, the techniques, designs, elements, and methods described and illustrated in the preferred embodiment as discrete or separate may be combined or integrated with other techniques designs, elements, or methods without departing from the scope of the present invention. Other examples of changes, substitutions, and alterations are readily ascertainable by one skilled in the art and could be made without departing from the spirit and scope of the present invention.

What is claimed is:

1. A method for competitively sealed bidding on debt obligations over a computer network, the method comprising:
inputting a first data into the computer network, the first data associated with a debt obligation desired by a borrower including a bid due date;
inputting a second data into the computer network, the second data associated with a bid request including a rate of the debt obligation by a lender to underwrite the debt obligation desired by the borrower; and
concealing from the borrower until the bid due date at least the rate of the debt obligation bid by the lender on the computer network.

2. The method of claim 1 wherein the debt obligation is a lease.

3. The method of claim 2 wherein the rate of the debt obligation bid by the lender includes a lease factor.

4. The method of claim 3 wherein the rate of the debt obligation bid by the lender includes a lease interest rate.

5. The method of claim 4 wherein the lease interest rate is a fixed interest rate.

6. The method of claim 4 wherein the lease interest rate is associated with a published interest rate.

7. The method of claim 4 wherein the lease interest rate is a variable interest rate.

8. The method of claim 4 wherein the rate of the debt obligation bid by the lender further includes a lease purchase option price.

9. The method of claim 1 wherein the debt obligation is a bond.

10. The method of claim 9 wherein the rate of the debt obligation bid by the lender includes a true interest cost.

11. The method of claim 10 wherein the rate of the debt obligation bid by the lender further includes a net interest cost.

12. The method of claim 1 wherein inputting second data associated with the bid request is further defined as inputting data associated with a plurality of bid requests including the rate of the debt obligation from a plurality of lenders to underwrite the debt obligation desired by the borrower.

13. The method of claim 12 further comprising determining prior to the bid due date the total number of bids input into the computer network in response to the debt obligation desired by the borrower.

14. The method of claim 13 further comprising determining information associated with the lender of the bid, the information including at least the lender name.

15. The method of claim 12 wherein the method further comprises:
viewing, by the borrower after the bid due date, the bids by the lenders, including the rate of the debt obligation;
awarding the bid selected by the borrower based upon the rate of the debt obligation bid by the lender; and
notifying the lender associated with the bid awarded by the borrower.

16. The method of claim 15 wherein the debt obligation is a lease and wherein the debt obligation rate includes an interest rate and a purchase option price and wherein the bid awarded by the borrower is selectively based upon
the interest rate and the purchase option price of the debt obligation bid by the lender.

17. The method of claim 16 further comprising:
modifying the first data associated with the debt obligation;
notifying at least a first lender that the first data has been modified;
modifying the second data associated with the lenders bid to underwrite the debt obligation desired by the borrower;
generating an amortization schedule based upon interest rate of the debt obligation bid by the lender;
calculating a purchase option price rate based upon the purchase option price of the debt obligation bid by the lender; and
generating an amortization schedule based upon the purchase option price rate calculated for the debt obligation.

18. The method of claim 17 wherein the lease is a tax exempt lease and wherein interest rate bid for the tax exempt lease is a tax exempt interest rate relative to a taxable interest rate by computing at least a state tax exemption, a federal tax rate and a cost of carry of the lender.

19. A method of competitively sealed bidding for debt obligations, the method comprising:
providing a computer network having a borrower system, a lender system and a sealed bidding system, the borrower system and the lender system in communication with the sealed bidding system;
inputting, via the borrower system, data associated with a debt obligation desired by a borrower including a bid due date;
inputting, via the lender system, data associated with a bid request by the lender to underwrite the debt obligation desired by the borrower, the bid including a rate of the debt obligation; and
concealing from the borrower system until the bid due date at least the rate of the debt obligation bid by the lender.

20. The method of claim 19 wherein the borrower system further includes a display device and the lender system further includes a display device.

21. The method of claim 20 wherein the method further comprises:
displaying on the lender system the debt obligation desired by the borrower; and
displaying on the lender system the bid due date.

22. The method of claim 21 wherein the bid due date includes a calendar date displayable on the lender system.

23. The method of claim 22 wherein the bid due date further includes a bid time associated with the calendar date for bids.

24. The method of claim 23 wherein the bid time is associated with a borrower time zone.

25. The method of claim 23 wherein the bid time is associated with a lender time zone.

26. The method of claim 23 wherein the bid due date further includes a countdown clock displayable on the lender system.

27. The method of claim 21 wherein inputting data associated with the bid request is further defined as inputting data associated with a plurality of bid requests including the rate of the debt obligation from a plurality of lenders to underwrite the debt obligation desired by the borrower.

28. The method of claim 27 wherein the method further comprises:
qualifying the lender;
viewing the lenders creditworthiness;
displaying on the borrower system after the bid due date the plurality of bids including the rate of the debt obligation bid by the plurality of lenders;
determining, by the borrower, a favorable bid from the plurality of bids;
awarding, by the borrower system, the favorable bid
displaying on the lender system a message indicative of the award by the borrower.

29. The method of claim 28 wherein the message indicative of the award to the bid selected by the borrower is further defined as a symbol indicative of the award.

30. A method for competitively sealed bidding on lease obligations over a computer network, the method comprising:
inputting a first data into the computer network, the first data associated with a lease obligation desired by a borrower including a bid due date;
inputting a second data into the computer network, the second data associated with a bid including a lease interest rate and a purchase option price by a lender to underwrite the lease obligation desired by the borrower; and
concealing from the borrower until the bid due date at least the lease interest rate and the purchase option price of the lease obligation bid by the lender on the computer network.

31. The method of claim 30 wherein the lease interest rate is a fixed interest rate.

32. The method of claim 30 wherein the lease interest rate is associated with a published interest rate.

33. The method of claim 30 wherein the lease interest rate is a variable interest rate.

34. The method of claim 30 further comprising generating an amortization schedule based upon interest rate of the debt obligation bid by the lender.

35. The method of claim 34 further comprising:
calculating a purchase option price rate based upon the purchase option price of the debt obligation bid by the lender; and
generating an amortization schedule based upon the purchase option price rate calculated for the debt obligation.

36. The method of claim 30 wherein inputting data associated with the bid request is further defined as inputting data associated with a plurality of bid requests from a plurality of lenders to underwrite the lease obligation desired by the borrower.

37. The method of claim 36 further comprising determining prior to the bid due date the total number of bids input into the computer network in response to the lease obligation desired by the borrower.

38. The method of claim 37 wherein the method further comprises:
viewing, by the borrower after the bid due date, the bids by the lenders, including the interest rate and the purchase option price of the lease obligation;
awarding the bid selected by the borrower based upon the lease interest rate and the purchase option price of the lease obligation; and
notifying the lender associated with the bid awarded by the borrower.

39. The method of claim 38 further comprising;
calculating an amortization of the lease obligation based upon the lease interest rate of the lease obligation; and
calculating an amortization of the lease obligation based upon the purchase option price of the lease obligation.

40. The method of claim 39 wherein the computer network is the Internet.

41. A computer-readable medium having computer- executable instructions for performing a the method comprising:
receiving data associated with a debt obligation desired by a borrower including a bid due date;
receiving data associated with a bid request including a rate of the debt obligation by a lender to underwrite the debt obligation desired by the borrower; and
concealing from the borrower until the bid due date at least the rate of the debt obligation bid by the lender on the computer network.

42. The method of claim 41 wherein the debt obligation is a lease.

43. The method of claim 41 wherein the rate of the debt obligation bid by the lender includes a lease factor.

44. The method of claim 41 wherein the rate of the debt obligation bid by the lender includes a lease interest rate.

45. The method of claim 44 wherein the lease interest rate is a fixed interest rate.

46. The method of claim 44 wherein the lease interest rate is associated with a published interest rate.

47. The method of claim 44 wherein the lease interest rate is a variable interest rate.

48. The method of claim 44 wherein the rate of the debt obligation bid by the lender further includes a lease purchase option price.

49. The method of claim 41 wherein the debt obligation is a bond.

50. The method of claim 49 wherein the rate of the debt obligation bid by the lender includes a true interest cost.

51. The method of claim 50 wherein the rate of the debt obligation bid by the lender further include net interest cost.

52. The method of claim 41 wherein inputting data associated with the bid request is further defined as inputting data associated with a plurality of bid requests including the rate of the debt obligation from a plurality of lenders to underwrite the debt obligation desired by the borrower.

53. The method of claim 52 further comprising determining prior to the bid due date the total number of bids input into the computer network in response to the debt obligation desired by the borrower.

54. The method of claim 53 further comprising determining information associated with the lender of the bid, the information including at least the lender name.

55. The method of claim 52 wherein the method further comprises:
assembling the plurality of bids by the plurality of lenders;
viewing, by the borrower after the bid due date, the assembled bids, including the rate of the debt obligation of the bids;
awarding the bid selected by the borrower based upon the rate of the debt obligation; and
notifying the lender associated with the bid awarded by the borrower.

56. The method of claim 55 wherein the debt obligation is a lease and wherein the rate of the debt obligation includes an interest rate and a purchase option price and wherein the bid awarded by the borrower is selectively based upon the interest rate and the purchase option price of the debt obligation bid by the lender.

57. The method of claim 55 wherein the method further comprises:
modifying, by the borrower, the data associated with the debt obligation desired by a borrower; and
modifying, by the lender, the data associated with the bid request by the lender to underwrite the debt obligation desired by the borrower.

58. The method of claim 57 wherein the data modified by the lender includes the rate of the debt obligation bid by the lender.

59. A system for competitively sealed bidding on debt obligations over a computer network, the system comprising:
a database component operative to maintain a database identifying a debt obligation desired by a borrower including a bid due date, the database further identifying a bid including a rate of the debt obligation by a lender to underwrite the debt obligation desired by the borrower; and
a security component operative to conceal at least the rate of the debt obligation bid by the lender from the borrower until the bid due date.

60. A system for competitively sealed bidding on a debt obligation, the system comprising:
a computer network including a main computer in communication with at least a first remote computer, the main computer adapted to retain debt obligation information including at least a bid due date; and
a means for confidentially maintaining at least a portion of a bid information until the bid due date.

61. The system of claim 61, further including an interest rate matrix retained by the main computer and accessible by the at least first remote computer for estimating an interest rate the debt obligation during a term of up to least 5 years for a plurality of entities.

62. The system of claim 62, wherein the interest rate matrix further includes a means for automatically calculating at least a portion of the interest rate matrix associated with one of the plurality of entities by providing at least a first interest rate.
